(19) United States
(12) Patent Application Publication
(10) Pub. No.: US 2021/0010480 A1
(43) Pub. Date: Jan. 14, 2021

(54) ILLUMINATION FAN

(71) Applicant: COOLER MASTER TECHNOLOGY INC., New Taipei City (TW)

(72) Inventor: Chen-Wei CHEN, New Taipei City (TW)

(73) Assignee: COOLER MASTER TECHNOLOGY INC., New Taipei City (TW)

(21) Appl. No.: 17/035,246

(22) Filed: Sep. 28, 2020

Related U.S. Application Data
(63) Continuation of application No. 15/966,954, filed on Apr. 30, 2018, now Pat. No. 10,830,243.

(51) Int. Cl. F04D 25/06; F04D 25/08; F04D 29/38

(52) U.S. Cl. CPC F04D 25/0613; F21Y 2115/10; F04D 29/388; F04D 25/08

(57) ABSTRACT

An illumination fan includes a first frame, a second frame, a fan blade, a light guide and a light source. The first frame includes an accommodation space. The second frame is assembled with the first frame, and an inner surface of the second frame is substantially flat. The fan blade is rotatably disposed in the accommodation space. The light source is disposed on either the first frame or the second frame. The light guide is disposed on the first frame and surrounds the fan blade.

### CROSS-REFERENCE TO RELATED APPLICATIONS

This non-provisional application is a continuation patent application of U.S. patent application Ser. No. 15/966,954 filed on Apr. 30, 2018, the entire contents of which are hereby incorporated by reference.

### TECHNICAL FIELD

The present disclosure relates to a fan in an electronic device, more particularly to an illumination fan.

### BACKGROUND

As an electronic device is used universally, it not only has to be practical but also to be attractive in its appearance. Nowadays, a chassis of a personal computer has evolved from a gray ugly box twenty years ago to a multi media consumer electronic product in variety of shapes. In order to enhance the appearance of the personal computer, one way is to make the cooling fan emit light.

A conventional illumination fan generally includes a fan housing, a fan blade, multiple LEDs and a light guide. The fan blade is rotatably disposed in the inside of the frame, and both the LEDs and the light guide are disposed around fan blade. The light emitted from the LEDs travels to the outside of the illumination fan through the light guide.

In the conventional illumination fan, for the convenience of assembly, the fan housing includes an upper frame and a lower frame which are assembled together, and the light guide is accommodated in a space formed by the lateral walls of the upper frame and the lower frame. Due to a manufacturing tolerance of the frame, the space is probably insufficient to accommodate the light guide. One solution is to form a relatively large space to ensure the assembling yield rate, but rendering a shortcoming that the size of the illumination fan is extremely large.

### SUMMARY

According to one aspect of the present disclosure, an illumination fan includes a first frame, a second frame, a fan blade, a light guide and a light source. The first frame includes an accommodation space. The second frame is assembled with the first frame, and an inner surface of the second frame is substantially flat. The fan blade is rotatably disposed in the accommodation space. The light source is disposed on either the first frame or the second frame. The light guide is disposed on the first frame and surrounds the fan blade.

According to another aspect of the present disclosure, an illumination fan includes a first frame, a second frame, a fan blade, a light guide and a light source. The first frame includes an accommodation space. The second frame is assembled with the first frame. The fan blade is rotatably disposed in the accommodation space. The light source is disposed on either the first frame or the second frame. The light guide is disposed on the first frame and surrounds the fan blade. Any portion of the second frame is not located between the fan blade and the light guide in a radial direction of the illumination fan.

According to still another aspect of the present disclosure, an illumination fan includes a first frame, a second frame, a fan blade, a light guide and a light source. The first frame includes an accommodation space. The second frame is assembled with the first frame, and there is no raised area on an inner surface of the second frame. The fan blade is rotatably disposed in the accommodation space. The light source is disposed on either the first frame or the second frame. The light guide is disposed on the first frame and surrounds the fan blade.

According to yet one aspect of the present disclosure, an illumination fan includes a first frame, a second frame, a fan blade, a light guide and a light source. The first frame includes a first lateral wall and a second lateral wall connected to each other. The first lateral wall and the second lateral wall jointly define an accommodation groove, and the first frame includes an accommodation space. The second frame is assembled with the first frame. The fan blade is rotatably disposed in the accommodation space, and the first lateral wall is closer to the fan blade than the second lateral wall. The light source is disposed on either the first frame or the second frame. The light guide is disposed in the accommodation groove and surrounds the fan blade.

According to yet still one aspect of the present disclosure, an illumination fan includes a first frame, a second frame, a fan blade, a light guide and a light source. The first frame includes a lateral wall and an accommodation space. The second frame is assembled with the first frame. The fan blade is rotatably disposed in the accommodation space, and the lateral wall of the first frame is located on a side of the fan blade. The light source is disposed on either the first frame or the second frame. The light guide is disposed on the first frame and surrounds the fan blade. The light guide includes at least one light guide portion and at least one protrusion located on a lateral side of the light guide portion facing toward the fan blade. The protrusion is fitted into at least one opening of the lateral wall.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1A is a perspective view of an illumination fan according to a first embodiment of the present disclosure;

FIG. 1B is an exploded view of the illumination fan in FIG. 1A;

FIG. 1C is a cross-sectional view of the illumination fan in FIG. 1A;

FIG. 2 is a cross-sectional view of an illumination fan according to a second embodiment of the present disclosure;

FIG. 3A is an exploded view of an illumination fan according to a third embodiment of the present disclosure;

FIG. 3B is a cross-sectional view of the illumination fan in FIG. 3A;

FIG. 4 is a cross-sectional view of an illumination fan according to a fourth embodiment of the present disclosure;

FIG. 5A is a top view of an illumination fan according to a fifth embodiment of the present disclosure;

FIG. 5B is a cross-sectional view of the illumination fan in FIG. 5A;

FIG. 6 is a cross-sectional view of an illumination fan according to a sixth embodiment of the present disclosure;

FIG. 7 is a cross-sectional view of an illumination fan according to a seventh embodiment of the present disclosure;

FIG. 8 is a cross-sectional view of an illumination fan according to an eighth embodiment of the present disclosure;

FIG. 9 is a cross-sectional view of an illumination fan according to a ninth embodiment of the present disclosure;

FIG. 10A is an exploded view of an illumination fan according to a tenth embodiment of the present disclosure;

FIG. 10B is a cross-sectional view of the illumination fan in FIG. 10A; and

FIG. 11 is a perspective view of an illumination fan according to an eleventh embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

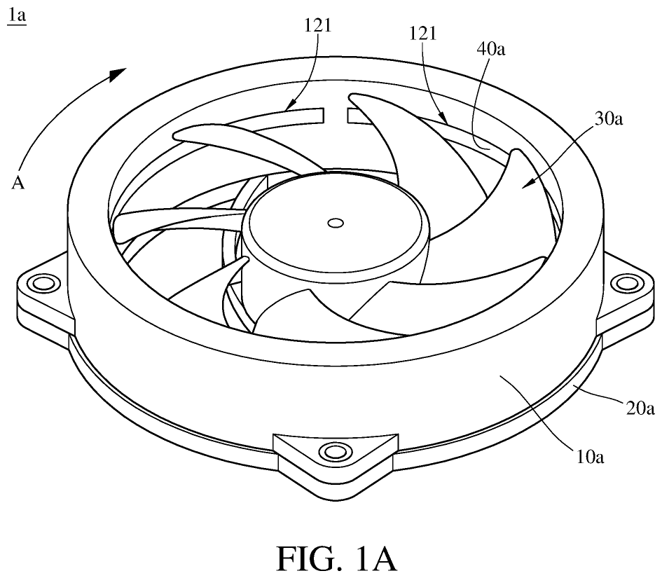

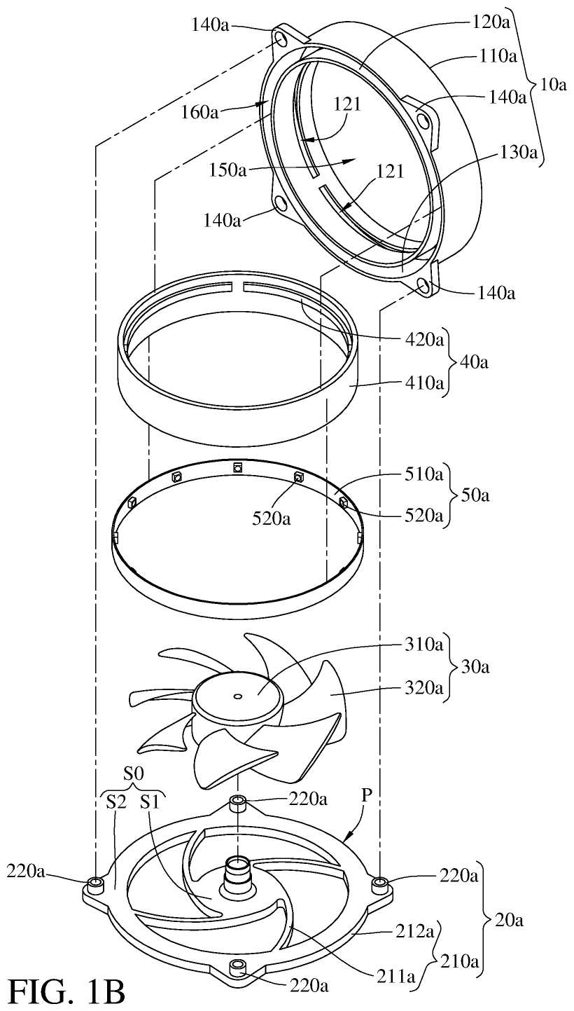

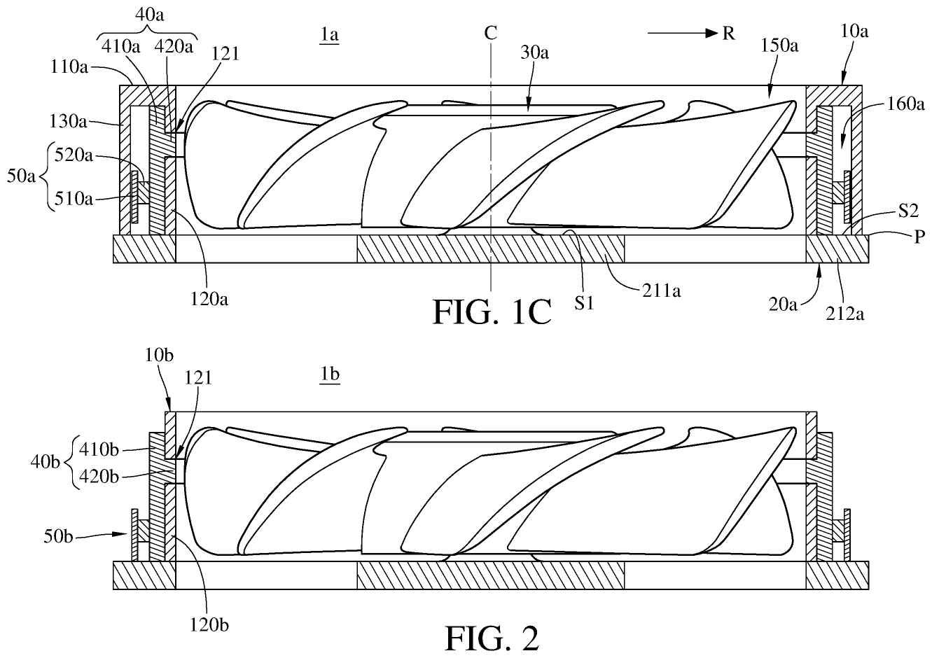

Please refer to FIG. 1A to FIG. 1C. FIG. 1A is a perspective view of an illumination fan according to a first embodiment of the present disclosure. FIG. 1B is an exploded view of the illumination fan in FIG. 1A. FIG. 1C is a cross-sectional view of the illumination fan in FIG. 1A. In this embodiment, an illumination fan 1 is disclosed, and the illumination fan 1a includes a first frame 10a, a second frame 20a, a fan blade 30a, a light guide 40a and a light source 50a. The illumination fan 1a is, for example but not limited to, a cooling fan accommodated in a chassis of a personal computer.

The first frame 10a is an upper frame of the illumination fan 1a which is made of opaque material, and the first frame 10a includes an upper cover 110a, a first lateral wall 120a, a second lateral wall 130a and a plurality of assembling structures 140a. The first lateral wall 120a and the second lateral wall 130a are connected to the upper cover 110a. The upper cover 110a and the first lateral wall 120a jointly define an accommodation space 150a. The first lateral wall 120a and the second lateral wall 130a jointly define an accommodation groove 160a. The assembling structures 140a are disposed on the second lateral wall 130a. The position of the assembling structure 140a, the shape of the assembling structure 140a and the number of the assembling structure 140a are not limited by the above. In this embodiment, each of the assembling structures 140a is a flange including a through hole. The first lateral wall 120a of the first frame 10a includes a plurality of openings 121 arranged in a circumferential direction A of the illumination fan 1a and surrounding the accommodation space 150a.

The second frame 20a is a lower frame of the illumination fan 1a which is made of opaque material, and the second frame 20a includes a frame body 210a and a plurality of assembling structures 220a located on an inner surface S0 of the frame body 210a. In detail, the frame body 210a includes a rib portion 211a and an annular portion 212a connected to each other. The assembling structures 220a are disposed on the annular portion 212a and located nearby a periphery P of the frame body 210a. The first frame 10a is assembled with the second frame 20a by the assembling structures 220a. The position of the assembling structure 220a, the shape of the assembling structure 220a and the number of the assembling structure 220a are not limited by the above. In this embodiment, each of the assembling structures 220a is a pin corresponding to the assembling structure 140a.

In this embodiment, the inner surface S0 of the frame body 210a is interpreted as a surface of the frame body 210a, which faces toward the first frame 10a, extends from a center C of the frame body 210a to the periphery P of the frame body 210a. That is, an inner surface S1 of the rib portion 211a and an inner surface S2 of the annular portion 212a jointly define the inner surface S0. The inner surface S1 is one section of the inner surface S0, and the inner surface S2 is the other section of the inner surface S0. The inner surface S0 of the frame body 210a is substantially flat; that is, both of the inner surfaces S1 and S2 are not sloping or curving.

The fan blade 30a is disposed in the accommodation space 150a and includes a rotor 310a and a plurality of vanes 320a. The vanes 320a are disposed on the rotor 310a, and the rotor 310a of the fan blade 30a is disposed on the rib portion 211a of the second frame 20a. The inner surface S0 of the frame body 210a faces toward the fan blade 30a. In this embodiment, the inner surface S1 of the rib portion 211a faces toward the fan blade 30a. In some embodiments, on the condition that the vanes 320a or the annular portion 212a has a large radial size, a part of the inner surface S2 of the annular portion 212a faces toward the fan blade 30a.

The light guide 40a is disposed on the first frame 10a and surrounds the fan blade 30a. In detail, the light guide 40a includes a light guide portion 410a and a plurality of protrusions 420a. The protrusions 420a are disposed on a lateral side of the light guide portion 410a facing toward the fan blade 30a, and each protrusion 420a is fitted into one of the openings 121 of the first lateral wall 120a. The first lateral wall 120a of the first frame 10a is located between the fan blade 30a and the light guide portion 410a. As shown in FIG. 1C, any portion of the second frame 20a is not located between the fan blade 30a and the light guide 40a in a radial direction R of the illumination fan 1a.

The light source 50a is disposed on the first frame 10a. In detail, the light source 50a is disposed in the accommodation groove 160a and located between the light guide 40a and the second lateral wall 130a of the first frame 10a. The light source 50a includes an annular circuit board 510a and a plurality of light emitting diodes (LEDs) 520a. The annular circuit board 510a surrounds the fan blade 30a, and the LEDs 520a are located on a side of the annular circuit board 510a close to the fan blade 30a.

When the LEDs 520a of the light source 50a illuminate, light rays generated by the LEDs 520a travel into the light guide 40a so as to make the light guide 40a emit light. In detail, light rays generated by the LEDs 520a travel into the light guide portion 410a of the light guide 40a and then exit from the protrusions 420a in the openings 121, thereby forming ring light at a proximity to the fan blade 30a.

The light guide 40a may include brushed surface so as to be favorable for even light intensity and soft emitted light. Furthermore, it is worth noting that the light source 50a includes the LEDs 520a is not limited by the above. In some other embodiments, the light source includes different illuminating component on the annular circuit board, such as florescent lights and organic LEDs.

The light guide 40a is made of transparent material having a larger transparency than the first frame 10a and the second frame 20a. The transparent material, for example, is poly(methyl methacrylate) (PMMA), cyclo olefin polymer (COP) or polycarbonate (PC), and the light guide 40a can be manufactured by injection molding. A total reflection of light in the light guide 40a makes the light rays generated by the light source 50a travel to a position relatively away from the light source 50a.

The fan blade 30a is also made of transparent material, such that the fan blade 30a can emit light when the light rays travel into the fan blade 30a from the light guide 40a, but the present disclosure is not limited thereto. The fan blade is made of opaque material in some other embodiments.

The first frame in the first embodiment includes the upper cover and the second lateral wall, but the present disclosure is not limited thereto. FIG. 2 is a cross-sectional view of an illumination fan according to a second embodiment of the present disclosure. Since the second embodiment is similar to the first embodiment, only the differences will be illustrated hereafter.

In this embodiment, an illumination fan 1b includes a first frame 10b without an upper cover and a second lateral wall. A light guide 40b is fastened to an opening 121 of a first lateral wall 120b of the first frame 10b so as to be disposed on the first frame 10b. An assembling structure (not shown in the drawings) of the first frame 10b is disposed on the first lateral wall 120b. A light source 50b is disposed on a light guide portion 410b of the light guide 40b.

Since the light guide portion 410b is not blocked by the first frame 10b, light rays generated by the light source 50b travel into the light guide 40b so as to form a ring light at the outside of the illumination fan 1b. Therefore, ring light is formed at both the inside and the outside of the illumination fan 1b, and thus the illumination fan 1b, which is different in appearance from the illumination fan 1a, is obtained.

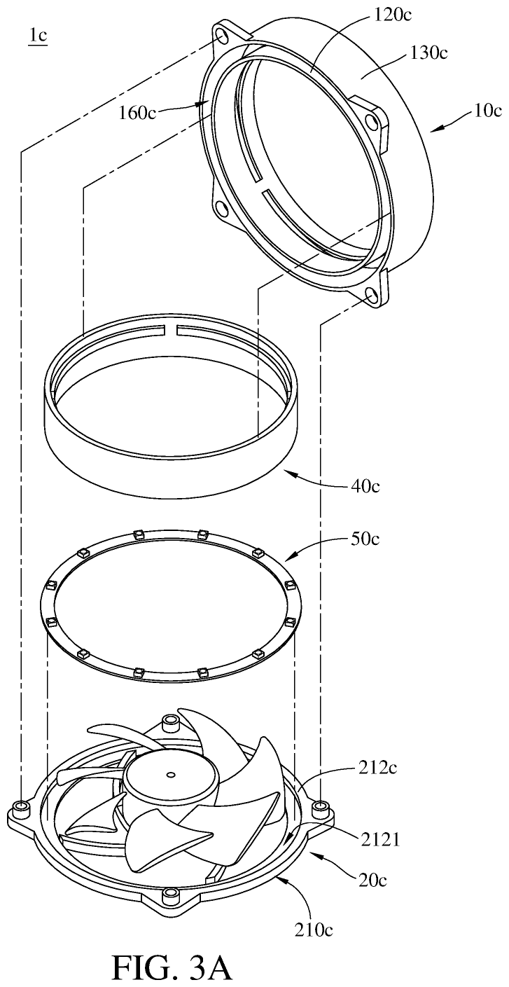

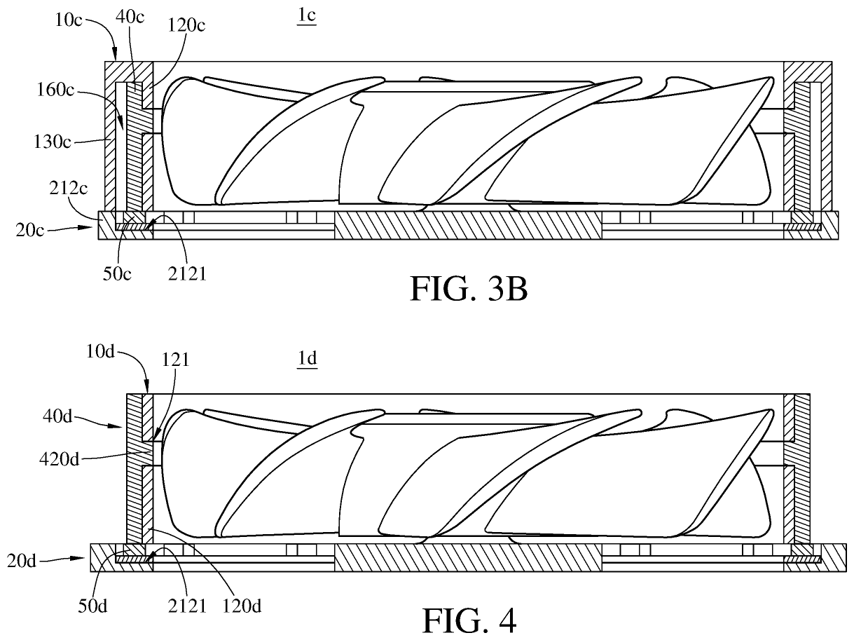

The inner surface of the second frame in the first embodiment is sub substantially flat, but the present disclosure is not limited thereto. FIG. 3A is an exploded view of an illumination fan according to a third embodiment of the present disclosure. FIG. 3B is a cross-sectional view of the illumination fan in FIG. 3A. Since the third embodiment is similar to the first embodiment, only the differences will be illustrated hereafter.

In this embodiment, an illumination fan 1c includes a second frame 20c including a frame body 210c, and the frame body 210c includes an annular portion 212c. The annular portion 212c includes a recess 2121, and a light source 50c is disposed in the recess 2121 instead of an accommodation groove 160c of a first frame 10c. Therefore, a proper space of the accommodation groove 160c can meet the size of a light guide 40c. Specifically, the gap between a first lateral wall 120c and a second lateral wall 130c of the first frame 10c for accommodating the light guide 40c is smaller than the gap between the first lateral wall 120a and the second lateral wall 130a in FIG. 1, such that a radial size of the illumination fan 1c is reduced so as to achieve compactness.

FIG. 4 is a cross-sectional view of an illumination fan according to a fourth embodiment of the present disclosure. Since the fourth embodiment is similar to the third embodiment, only the differences will be illustrated hereafter.

In this embodiment, an illumination fan 1d includes a first frame 10d without an upper cover and a second lateral wall. A light guide 40d is disposed on the first frame 10d by fitting a protrusion 420d into an opening 121 of a first lateral wall 120d of the first frame 10d b. A light source 50d is disposed in a recess 2121 of a second frame 20d.

Since a light guide portion 410d of the light guide 40d is not blocked by the first frame 10d, light rays generated by the light source 50d travel into the light guide 40d so as to form a ring light at the outside of the illumination fan 1d. The recess 2121 for accommodating the light source 50d is favorable for the light guide portion 410d to cover the light source 50d so as to obtain the illumination fan 1d having better appearance.

The illumination fans in the first through the fourth embodiments each include the second frame, and there is no raised area on the inner surface of the frame body of the second frame. In detail, in the first and the second embodiments, the inner surface of the frame body is substantially flat; and in the third and the fourth embodiments, the inner surface of the frame body includes a recess.

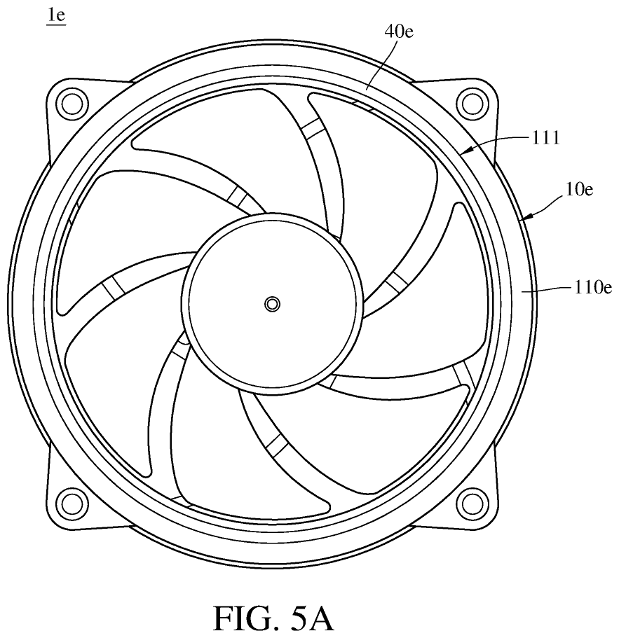

A ring light is formed at the proximity to the fan blade in the first embodiment, but the present disclosure is not limited thereto. FIG. 5A is a top view of an illumination fan according to a fifth embodiment of the present disclosure. FIG. 5B is a cross-sectional view of the illumination fan in FIG. 5A. Since the fifth embodiment is similar to the first embodiment, only the differences will be illustrated hereafter.

In this embodiment, an illumination fan le includes a first frame 10e including an upper cover 110e, and a part of a light guide portion 410e of a light guide 40e is disposed in an annular opening 111 of the first frame 10e. Light rays generated by the light source 50e travel into the light guide 40e and then exit from the part of the light guide portion 410e in the annular opening 111, thereby forming a ring light at the top of the first frame 10e. The light guide 40e is favorable for forming ring lights at both the top of the first frame 10e and the lateral side of the first frame 10e so as to obtain the illumination fan 1e with different appearance from the illumination fans 1a and 1b.

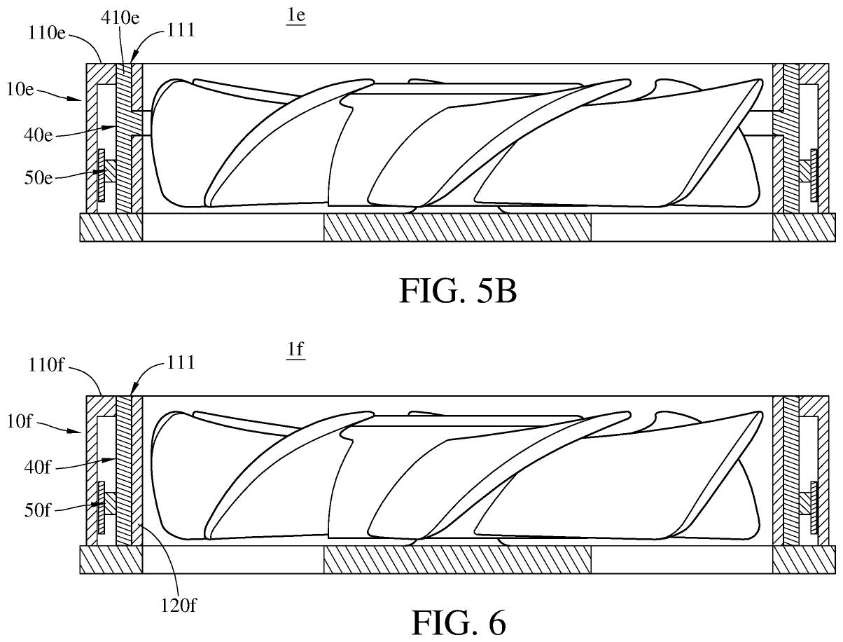

FIG. 6 is a cross-sectional view of an illumination fan according to a sixth embodiment of the present disclosure. Since the sixth embodiment is similar to the fifth embodiment, only the differences will be illustrated hereafter.

In this embodiment, an illumination fan 1f includes a first frame 10f including an upper cover 110f and a light guide 40f without protrusion. A part of a light guide portion 410f of a light guide 40f is disposed in an annular opening 111 of the first frame 10f. The first frame 10f further includes a first lateral wall 120f without opening. Light rays generated by a light source 50f travel into the light guide 40f and then exit from the part of the light guide portion 410f in the annular opening 111, thereby forming a ring light at the top of the first frame 10f.

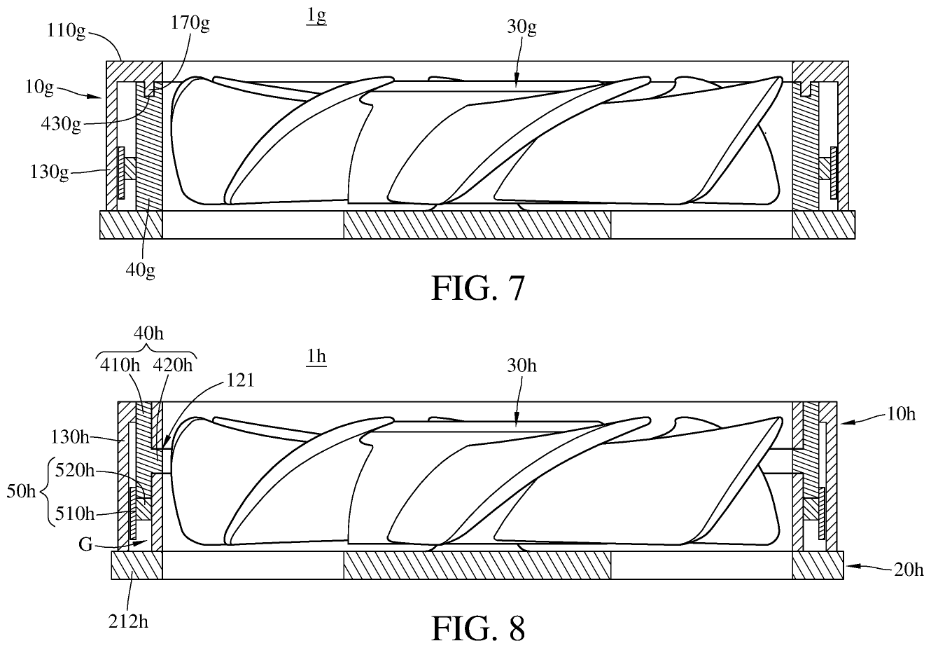

FIG. 7 is a cross-sectional view of an illumination fan according to a seventh embodiment of the present disclosure. Since the seventh embodiment is similar to the first embodiment, only the differences will be illustrated hereafter.

In this embodiment, an illumination fan 1g includes a first frame 10g without a first lateral wall. The first frame 10g includes an upper cover 110g, a second lateral wall 130g and an annular flange 170g located on the upper cover 110g. A light guide 40g, without protrusion, includes an annular slot 430g located on a side of the light guide 40g close to the upper cover 110g. The light guide 40g is disposed on the first frame 10g by fastening the annular flange 170g into the annular slot 430g. Light rays travel into the light guide 40g and then exit from a side of the light guide 40g close to a fan blade 30g. Since the lateral side of the light guide 40g is not blocked by the first frame 10g, a larger ring light is formed at the proximity to the fan blade 30g.

The light source in the first embodiment is disposed between the light guide and the second lateral wall of the first frame, but the present disclosure is not limited thereto. FIG. 8 is a cross-sectional view of an illumination fan according to an eighth embodiment of the present disclosure. Since the eighth embodiment is similar to the first embodiment, only the differences will be illustrated hereafter.

In this embodiment, an illumination fan 1h includes a light guide 40h and a second frame 20h. There is an air gap G between a light guide portion 410h of the light guide 40h and an annular portion 212h of the second frame 20h. A light source 50h is disposed in the air gap G so as to be located below the light guide portion 410h. In detail, a plurality of LEDs 520h of the light source 50h are disposed below the light guide portion 410h, and a part of an annular circuit board 510h is located between the light guide portion 410h and a second lateral wall 130h. The arrangement of the light source 50h is favorable for reducing the radial size of the illumination fan 1h. The light rays generated by the light source 50h travel into the light guide 40h, thereby forming a ring light at both the top of a first frame 10h and the proximity to a fan blade 30h.

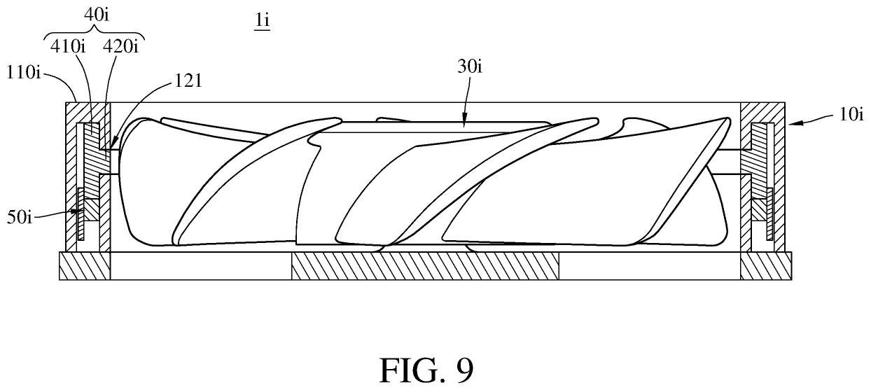

FIG. 9 is a cross-sectional view of an illumination fan according to a ninth embodiment of the present disclosure. Since the ninth embodiment is similar to the eighth embodiment, only the differences will be illustrated hereafter.

In this embodiment, an illumination fan 1i includes a first frame 10i including an upper cover 110i without annular opening. Therefore, light rays generated by a light source 50i travel into a light guide portion 410i of the light guide 40i and then only exit from a protrusion 420i of the light guide 40i in an opening 121 of the first frame 10i.

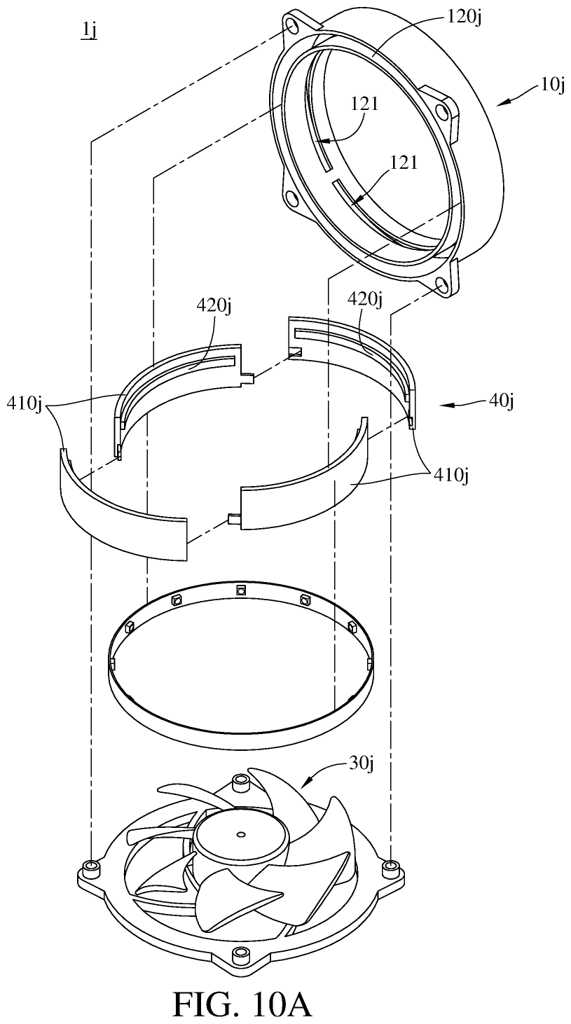

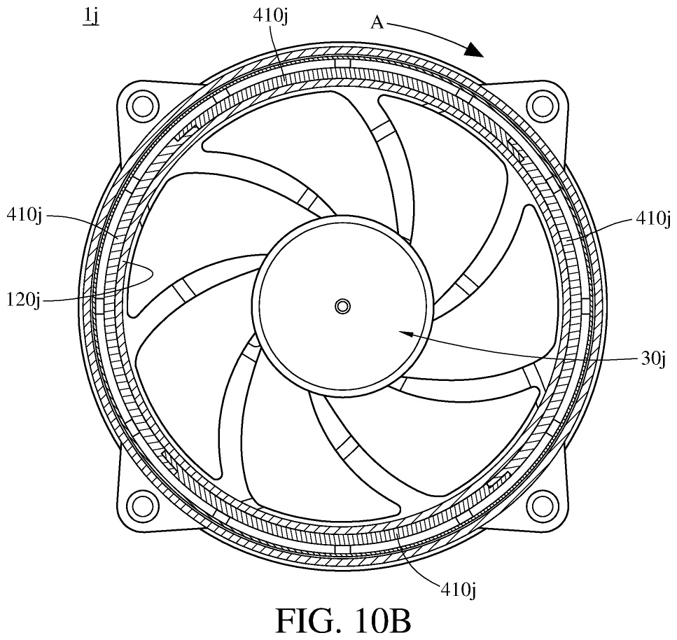

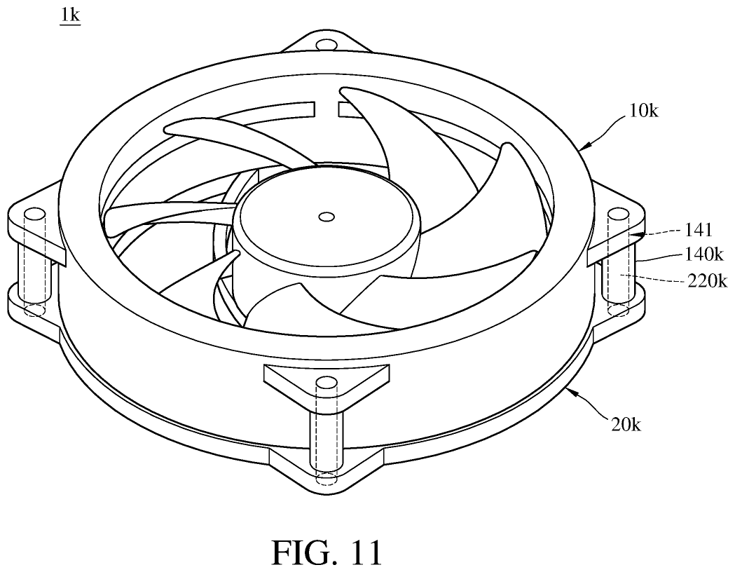

The light guide in the first embodiment is a single piece, but the present disclosure is not limited thereto. FIG. 10A is an exploded view of an illumination fan according to a tenth embodiment of the present disclosure. FIG. 10B is a cross-sectional view of the illumination fan in FIG. 10A. Since the tenth embodiment is similar to the first embodiment, only the differences will be illustrated hereafter.

In this embodiment, an illumination fan 1j includes a light guide 40j, and the light guide 40j includes a plurality of light guide portions 410j which are assembled with each other. In detail, each of the light guide portions 410j is assembled with the other adjacent two of the light guide portions 410j, such that the light guide portions 410j surround a first lateral wall 120j of a first frame 10j. The light guide portions 410j are assembled with each other by, for example, a combination of latch and slot. In some other embodiments, the light guide portions 410j are assembled with each other by adhesion or screw.

The first lateral wall 120j of the first frame 10j includes a plurality of openings 121 arranged in the circumferential direction A of the illumination fan 1h. The light guide 40j further includes a plurality of protrusions 420j which are respectively located on lateral sides of the light guide portions 410j facing toward a fan blade 30j, and the protrusions 420j of the light guide 40j are respectively fitted into the openings 121. The light guide 40j formed by the assembly of the light guide portions 410j surrounds the first lateral wall 120j to allow ring light at the proximity to the fan blade 30j. The assembly of the light guide portions 410j is favorable for an easier installation of the light guide 40j to the first frame 10j so as to prevent overly dragging and pulling the light guide 40j during assembly.

In the first embodiment, the assembling structure of the first frame is a flange having through hole, and the assembling structure of the second frame is a pin corresponding to the aforementioned through hole, but the present disclosure is not limited thereto. FIG. 11 is a perspective view of an illumination fan according to an eleventh embodiment of the present disclosure. Since the eleventh embodiment is similar to the first embodiment, only the differences will be illustrated hereafter.

In this embodiment, an illumination fan 1k includes a first frame 10k and a second frame 20k. Each of an assembling structure 140k of the first frame 10k and an assembling structure 220k of the second frame 20k is a pin. The diameter of the assembling structure 140k is larger than the diameter of the assembling structure 220k, and the assembling structure 140k includes a hole 141. The first frame 10k is assembled with the second frame 20k by inserting the assembling structure 220k into the hole 141 of the assembling structure 140k.

A difficult assembly of the components of a conventional illumination fan and an overly large size of the conventional illumination fan are some problems to be solved. Compared to the conventional illumination fan which includes the upper frame and the lower frame jointly forming a space for accommodating the light guide, the illumination fan of the present disclosure includes the upper frame (first frame) defining the accommodation groove for accommodating the light guide. Therefore, it is favorable for preventing insufficient amount of accommodation groove due to manufacturing tolerance.

According to one aspect of the present disclosure, the light guide includes the light guide portion and the protrusions. The light guide is disposed on the first frame by fitting the protrusions into the openings of the first frame. Therefore, the first frame is provided without an outer lateral wall since it is not necessary to dispose the light guide in an accommodation groove, thereby reducing the size of the illumination fan.

According to another aspect of the present disclosure, the second frame includes an inner surface which is substantially flat in some embodiments; any portion of the second frame is not located between the fan blade and the light guide in a radial direction of the illumination fan in some other embodiments; and there is no raised area on the inner surface of the second frame in still some other embodiments. A configuration of the second frame is favorable for preventing the accommodation groove, where the light guide is located, from being occupied by the second frame. Besides, the light source can be disposed on the inner surface of the second frame. Therefore, a smaller radial size and better appearance of the illumination fan are obtained.

The embodiments are chosen and described in order to best explain the principles of the present disclosure and its practical applications, to thereby enable others skilled in the art to best utilize the present disclosure and various embodiments with various modifications as are suited to the particular use being contemplated. It is intended that the scope of the present disclosure is defined by the following claims and their equivalents.

What is claimed is:

1. An illumination fan, comprising:
a first frame comprising an accommodation space;
a second frame assembled with the first frame, and an inner surface of the second frame being substantially flat;
a fan blade rotatably disposed in the accommodation space;
a light source disposed on either the first frame or the second frame; and
a light guide disposed on the first frame and surrounding the fan blade.

2. The illumination fan according to claim 1, wherein the second frame comprises a frame body and an assembling structure, the frame body comprises the inner surface, the assembling structure is located on the inner surface, and the first frame is assembled with the second frame by the assembling structure.

3. The illumination fan according to claim 2, wherein the assembling structure is disposed nearby a periphery of the frame body, and the inner surface of the frame body faces toward the fan blade.

4. The illumination fan according to claim 2, wherein the inner surface of the frame body extends from a center of the frame body to a periphery of the frame body.

5. The illumination fan according to claim 2, wherein the frame body comprises an annular portion and a rib portion connected to each other, the assembling structure is disposed on the annular portion, the fan blade is disposed on the rib portion, and an inner surface of the annular portion and an inner surface of the rib portion jointly define the inner surface of the frame body.

6. The illumination fan according to claim 1, wherein any portion of the second frame is not located between the fan blade and the light guide in a radial direction of the illumination fan.

7. The illumination fan according to claim 1, wherein the first frame comprises a first lateral wall, and the light guide is disposed on the first lateral wall.

8. The illumination fan according to claim 7, wherein the light guide comprises a light guide portion and a protrusion located on a lateral side of the light guide portion facing toward the fan blade, and the protrusion is fitted into an opening of the first lateral wall of the first frame.

9. The illumination fan according to claim 7, wherein the first frame further comprises a second lateral wall connected to the first lateral wall, the first lateral wall is closer to the fan blade than the second lateral wall, the first lateral wall and the second lateral wall jointly define an accommodation groove, and the light guide is disposed in the accommodation groove.

10. The illumination fan according to claim 9, wherein the light source is disposed on the first frame and in the accommodation groove.

11. The illumination fan according to claim 10, wherein the light source is located between the light guide and the second lateral wall.

12. The illumination fan according to claim 1, wherein the first frame comprises an accommodation groove, an opening of the accommodation groove faces toward the inner surface of the second frame, and the inner surface of the second frame covers the opening of the accommodation groove, and the light guide is disposed in the accommodation groove of the first frame through the opening of the accommodation groove.

13. An illumination fan, comprising:
a first frame comprising an accommodation space;
a second frame assembled with the first frame;
a fan blade rotatably disposed in the accommodation space;
a light source disposed on either the first frame or the second frame; and
a light guide disposed on the first frame and surrounding the fan blade, and any portion of the second frame being not located between the fan blade and the light guide in a radial direction of the illumination fan.

14. The illumination fan according to claim 13, wherein the second frame comprises a frame body and an assembling structure located on an inner surface of the frame body, the first frame is assembled with the second frame by the assembling structure, and the inner surface of the frame body faces toward the fan blade.

15. The illumination fan according to claim 14, wherein the inner surface of the frame body extends from a center of the frame body to a periphery of the frame body.

16. The illumination fan according to claim 14, wherein the first frame comprises a first lateral wall, and the light guide is disposed on the first lateral wall.

17. The illumination fan according to claim 16, wherein the frame body comprises an annular portion and a rib portion connected to each other, the assembling structure is disposed on the annular portion, the fan blade is disposed on the rib portion, and the light source is disposed in a recess of the annular portion.

18. The illumination fan according to claim 16, wherein the light guide comprises a light guide portion and a protrusion located on a lateral side of the light guide portion facing toward the fan blade, and the protrusion is fitted into an opening of the first lateral wall of the first frame.

19. The illumination fan according to claim 16, wherein the light guide comprises a plurality of light guide portions and a plurality of protrusions, the light guide portions are assembled with each other, the protrusions are respectively located on lateral sides of the light guide portions facing toward the fan blade, a plurality of openings of the first lateral wall of the first frame are arranged in a circumferential direction of the illumination fan, and the protrusions of the light guide are respectively fitted into the openings.

20. The illumination fan according to claim 16, wherein the first frame further comprises a second lateral wall connected to the first lateral wall, the first lateral wall is closer to the fan blade than the second lateral wall, the first lateral wall and the second lateral wall jointly define an accommodation groove, and the light guide is disposed in the accommodation groove.

21. The illumination fan according to claim 20, wherein the light source is disposed in the accommodation groove.

22. The illumination fan according to claim 21, wherein the light source is located between the light guide and the second lateral wall.

23. An illumination fan, comprising:
a first frame comprising an accommodation space;
a second frame assembled with the first frame, wherein there is no raised area on an inner surface of the second frame;
a fan blade rotatably disposed in the accommodation space;
a light source disposed on either the first frame or the second frame; and
a light guide disposed on the first frame and surrounding the fan blade.

24. The illumination fan according to claim 23, wherein the second frame comprises a frame body and an assembling structure, the frame body comprises the inner surface, the assembling structure is located on the inner surface, and the first frame is assembled with the second frame by the assembling structure.

25. The illumination fan according to claim 24, wherein the assembling structure is disposed nearby a periphery of the frame body, and the inner surface of the frame body faces toward the fan blade.

26. The illumination fan according to claim 24, wherein the inner surface of the frame body extends from a center of the frame body to a periphery of the frame body.

27. The illumination fan according to claim 24, wherein the frame body comprises an annular portion and a rib portion connected to each other, the assembling structure is disposed on the annular portion, the fan blade is disposed on the rib portion, and an inner surface of the annular portion and an inner surface of the rib portion jointly define the inner surface of the frame body.

28. The illumination fan according to claim 27, wherein the light source is disposed in a recess of the annular portion.

29. The illumination fan according to claim 23, wherein the first frame comprises a first lateral wall, and the light guide is disposed on the first lateral wall.

30. The illumination fan according to claim 29, wherein the light guide comprises a light guide portion and a protrusion located on a lateral side of the light guide portion facing toward the fan blade, and the protrusion is fitted into an opening of the first lateral wall of the first frame.

31. The illumination fan according to claim 29, wherein the light guide comprises a plurality of light guide portions and a plurality of protrusions, the light guide portions are assembled with each other, the protrusions are respectively located on lateral sides of the light guide portions facing toward the fan blade, a plurality of openings of the first lateral wall of the first frame are arranged in a circumferential direction of the illumination fan, and the protrusions of the light guide are respectively fitted into the openings.

32. The illumination fan according to claim 29, wherein the first frame further comprises a second lateral wall connected to the first lateral wall, the first lateral wall is closer to the fan blade than the second lateral wall, the first lateral wall and the second lateral wall jointly define an accommodation groove, and the light guide is disposed in the accommodation groove.

33. The illumination fan according to claim 32, wherein the light source is disposed in the accommodation groove.

34. The illumination fan according to claim 33, wherein the light source is located between the light guide and the second lateral wall.

35. An illumination fan, comprising:
a first frame comprising a first lateral wall and a second lateral wall connected to each other, the first lateral wall and the second lateral wall jointly defining an accommodation groove, and the first frame comprising an accommodation space;
a second frame assembled with the first frame;
a fan blade rotatably disposed in the accommodation space, and the first lateral wall being closer to the fan blade than the second lateral wall;
a light source disposed on either the first frame or the second frame; and
a light guide disposed in the accommodation groove and surrounding the fan blade.

36. The illumination fan according to claim 35, wherein any portion of the second frame is not located between the fan blade and the light guide in a radial direction of the illumination fan.

37. The illumination fan according to claim 35, wherein the second frame comprises a frame body and an assembling structure, the assembling structure is located on an inner surface of the frame body, the first frame is assembled with the second frame by the assembling structure, and there is no raised area on the inner surface of the frame body.

38. The illumination fan according to claim 37, wherein the frame body comprises an annular portion and a rib portion connected to each other, the assembling structure is disposed on the annular portion, the fan blade is disposed on the rib portion, and the light source is disposed in a recess of the annular portion.

39. The illumination fan according to claim 35, wherein the light guide comprises a light guide portion and a protrusion located on a lateral side of the light guide portion facing toward the fan blade, and the protrusion is fitted into an opening of the first lateral wall of the first frame.

40. The illumination fan according to claim 35, wherein the light guide comprises a plurality of light guide portions and a plurality of protrusions, the light guide portions are assembled with each other, the protrusions are respectively located on lateral sides of the light guide portions facing toward the fan blade, a plurality of openings of the first lateral wall of the first frame are arranged in a circumferential direction of the illumination fan, and the protrusions of the light guide are respectively fitted into the openings.

41. The illumination fan according to claim 35, wherein the light source is disposed in the accommodation groove.

42. The illumination fan according to claim 41, wherein the light source is located between the light guide and the second lateral wall.

43. An illumination fan, comprising:
a first frame comprising a lateral wall and an accommodation space;
a second frame assembled with the first frame;
a fan blade rotatably disposed in the accommodation space, and the lateral wall of the first frame being located on a side of the fan blade;
a light source disposed on either the first frame or the second frame; and
a light guide disposed on the first frame and surrounding the fan blade, the light guide comprising at least one light guide portion and at least one protrusion located on a lateral side of the at least one light guide portion facing toward the fan blade, and the at least one protrusion is fitted into at least one opening of the lateral wall.

44. The illumination fan according to claim 43, wherein numbers of the at least one opening, the at least one light guide portion and the at least one protrusion are multiple, the protrusions are respectively located on the light guide portions, the openings are arranged in a circumferential direction of the illumination fan, and the protrusions are respectively fitted into the openings.

45. The illumination fan according to claim 44, wherein one of the light guide portions is assembled with the other two of the light guide portions.

46. The illumination fan according to claim 43, wherein there is an air gap between the at least one light guide portion and the second frame.

47. The illumination fan according to claim 46, wherein the light source is located below the at least one light guide portion.

48. The illumination fan according to claim 43, wherein any portion of the second frame is not located between the fan blade and the light guide in a radial direction of the illumination fan.

49. The illumination fan according to claim 43, wherein the first frame further comprises a second lateral wall connected to the first lateral wall, the first lateral wall is closer to the fan blade than the second lateral wall, the first lateral wall and the second lateral wall jointly define an accommodation groove, and the at least one light guide portion of the light guide is disposed in the accommodation groove.

50. The illumination fan according to claim 49, wherein the light source is located between the at least one light guide portion and the second lateral wall.
